(19) United States
(12) Patent Application Publication
(10) Pub. No.: US 2008/0007621 A1
(43) Pub. Date: Jan. 10, 2008

(54) System and method of controlling access to an entrance

(75) Inventors: Goangshiuan Ying, Oakland, CA (US); Eugene L. Edmon, Danville, CA (US); Julie D. Lorentzen, Pleasanton, CA (US); Steve M. Aspell, Brentwood, CA (US); Ronald Brost, Vacaville, CA (US)

Correspondence Address: TOLER SCHAFFER, LLP, 8500 BLUFFSTONE COVE, SUITE A201, AUSTIN, TX, 78759, US

(73) Assignee: SBC Knowledge Ventures, LP, Reno, NV (US)

(21) Appl. No.: 11/482,183

(22) Filed: Jul. 6, 2006

(51) Int. Cl. H04N 7/18; H04N 7/14; H04M 1/60; G07C 11/00

(52) U.S. Cl. 348/156; 348/14.01; 340/286.06; 379/167.12

(57) ABSTRACT

The present disclosure is directed to a system and method of controlling access to an entrance. In a particular embodiment, the method includes receiving a first signal, first data, or any combination thereof, at an audio video transport system indicating that a request to access an entrance has been received via a security system. The method also includes determining a set-top box device associated with the request. Further, the method includes sending a second signal, second data, or any combination thereof, to a network terminal indicating that the request has been received, wherein the network terminal communicates video content of an Internet Protocol Television (IPTV) system to the set-top box device. The network terminal communicates an alert to the set-top box device indicating that the request has been received, the alert overlaying the video content at a display device coupled to the set-top box device.

### FIELD OF THE DISCLOSURE

The present disclosure relates generally to controlling access to an entrance.

### BACKGROUND

Security is a priority for most individuals. Alarm systems, gated properties and communities, and surveillance systems have become popular amenities for most dwellings. Individuals often feel safer if access to entrances of a dwelling, property, neighborhood, or complex is restricted. At the same time, few people want to sacrifice convenience for security. Systems that enable users to grant or deny access to an entrance remotely via telephone, for example, are common. Nonetheless, these systems can be limited in the options they present to users. Telephone-based systems typically do not allow users to view a party requesting access to an entrance. Systems that do provide images of the party often require the user to interrupt a current activity to view a security monitor. Moreover, such systems can require a host of specialized equipment that provides few, if any, other functions that are attractive to the user. Hence, there is a need for an improved system and method of controlling access to an entrance.

### BRIEF DESCRIPTION OF THE DRAWINGS

FIG. 1 is a block diagram of a particular illustrative embodiment of a system to control access to an entrance;

FIG. 2 is a block diagram of a second particular illustrative embodiment of a system to control access to an entrance;

FIG. 3 is a flow diagram of a particular illustrative embodiment of a method of controlling access to an entrance;

FIG. 4 is a flow diagram of a second particular embodiment of a method of controlling access to an entrance;

FIG. 5 is a flow diagram of a third particular illustrative embodiment of a method of controlling access to an entrance;

FIG. 6 is a diagram of an illustrative embodiment of a user interface to control access to an entrance; and

FIG. 7 is a diagram of an illustrative embodiment of a general computer system.

### DETAILED DESCRIPTION OF THE DRAWINGS

The present disclosure is directed to a system that includes an audio video transport device having a processor and a memory device accessible to the processor. The memory device includes instructions executable by the processor to receive a first signal, first data, or any combination thereof, from a security system indicating that a request to access an entrance has been received. The memory device also includes instructions executable by the processor to determine a set-top box device associated with the request. The memory device also includes instructions executable by the processor to send a second signal, second data, or any combination thereof, to a network terminal indicating that the request has been received, where the network terminal communicates video content of an Internet Protocol Television (IPTV) system to the set-top box device. The network terminal communicates an alert to the set-top box device indicating that the request has been received, the alert overlaying the video content at a display device coupled to the set-top box device.

In another embodiment, the disclosure is directed to a set-top box device having a processor and a memory device accessible to the processor. The memory device includes instructions executable by the processor to receive video content of an Internet Protocol Television (IPTV) system from a network terminal. Further, the memory device includes instructions executable by the processor to receive a signal, data, or any combination thereof, from the network terminal indicating that a request to access an entrance has been received at a security system that communicates with the network terminal via an audio video transport system. In addition, the memory device includes instructions executable by the processor to send an alert to a display device coupled to the set-top box device, the alert indicating that the request has been received and overlaying the video content at the display device.

In another embodiment, the disclosure is directed to a method of controlling access to an entrance that includes receiving a first signal, first data, or any combination thereof, at an audio video transport system indicating that a request to access an entrance has been received via a security system. The method also includes determining a set-top box device associated with the request. Further, the method includes sending a second signal, second data, or any combination thereof, to a network terminal indicating that the request has been received, where the network terminal communicates video content of an Internet Protocol Television (IPTV) system to the set-top box device. The network terminal communicates an alert to the set-top box device indicating that the request has been received, the alert overlaying the video content at a display device coupled to the set-top box device.

In another embodiment, the disclosure is directed to a method of controlling access to an entrance that includes sending video content of an Internet Protocol Television (IPTV) system to a set-top box device. The method also includes receiving a signal, data, or any combination thereof, from an audio video transport system indicating that a request to access an entrance has been received via a security system, where the signal, data, or any combination thereof includes an identification of the set-top box device. The method also includes communicating an alert to the set-top box device indicating that the request has been received, the alert overlaying the video content at a display device coupled to the set-top box device.

In another embodiment, the disclosure is directed to a method of controlling access to an entrance that includes receiving video content of an Internet Protocol Television (IPTV) system at a set-top box device from a network terminal. The method also includes receiving a signal, data, or any combination thereof, from the network terminal indicating that a request to access an entrance has been received at a security system that communicates with the network terminal via an audio video transport system. The method also includes sending an alert to a display device coupled to the set-top box device, where the alert indicates that the request has been received and overlays video content at the display device.

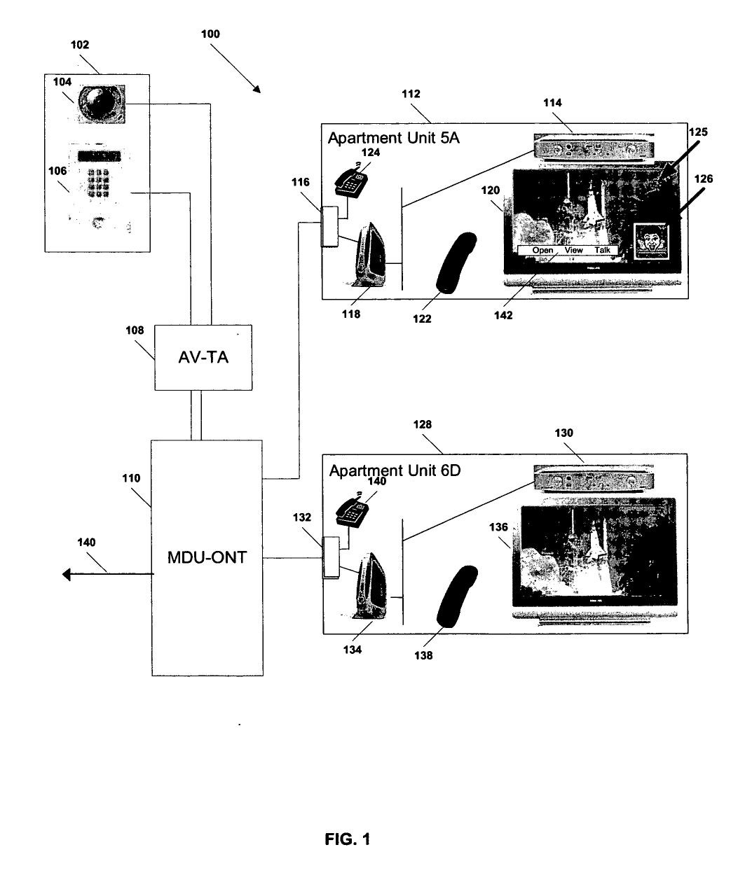

Referring to FIG. 1, an illustrative embodiment of a system to control access to an entrance is illustrated and is generally designated 100. As shown, the system 100 can include a security system 102. In a particular embodiment, the security system 102 can have a video camera 104 and a keypad device 106. In an illustrative embodiment, the keypad device 106 can include a microphone and one or more speakers to facilitate verbal communication. The security system 102 can be located at an entrance to one or more premises, such as outside a door, gate, or other entrance of a single dwelling or property. In another embodiment, the security system 102 can be located at an entrance to one or more premises, such as outside a door, gate, or other entrance of a multiple-unit dwelling or a neighborhood, such as an apartment, townhouse or condominium complex, or a gated neighborhood.

In a particular embodiment, the security system 102 can communicate with an audio video transport device (AV-TD) 108 that exchanges information with the security system 102. Further, the AV-TD 108 can communicate with a network terminal 110, such as a multi-dwelling unit optical network terminal (MDU-ONT). In an illustrative embodiment, the AV-TD 108 can communicate with the network terminal 110 via a registered jack 45 (RJ45) cable, Ethernet connection, virtual local area network (VLAN) connection, other network connection, or any combination thereof.

In a particular embodiment, the network terminal 110 can communicate with one or more dwellings 112, 128, such as one or more apartment units. The network terminal 110 can communicate with set-top box devices 114, 130 at the dwellings 112, 128 via customer premise equipment (CPE) 118, 134, such as a router, a local area network device, a modem, any other suitable device to facilitate communication between the set-top box devices 114, 130 and the network terminal 110, or any combination thereof. In an illustrative embodiment, the network terminal 110 can communicate with each dwelling via network interfaces 116, 132 that facilitate communication between the network terminal 110 and a variety of user devices, such as phones 124, 140, CPE 118, 134, set-top box devices 114, 130, display devices 120, 136, or any combination thereof.

In a particular embodiment, the network terminal 110 can receive video content, of television or movie programming from a central office or optical line terminal (OLT) via one or more communication lines 140, such as a fiber line, twisted pair, coaxial cable, or any combination thereof. In an illustrative embodiment, the network terminal 110 can receive video content from one or more video servers of an Internet Protocol Television (IPTV) system. The network terminal 110 can send the video content to multiple set-top box devices 114, 130 via the customer premise equipment (CPE) 118, 134 at various dwellings 112, 128. In an illustrative embodiment, the video content can be displayed via display devices, such as the television monitors 120, 136, that are coupled to the set-top box devices 114, 130.

In a particular embodiment, a party can seek access to an entrance, such as a door of a dwelling, a gate or door of a multiple dwelling unit building or complex, an entrance to a property, or any combination thereof, via the security system 102. For example, the party can use the keypad device 106 to request access to an entrance, such as a gate at an apartment complex. In response to the request, the security system 102 can send a signal, data, or any combination thereof, to the AV-TD 108 indicating that a party seeks access to the entrance. In an illustrative embodiment, the request can identify a particular dwelling, occupant, or any combination thereof, and the signal can include an indication of the dwelling, occupant, or any combination thereof, associated with the request.

In a particular embodiment, the AV-TD 108 can identify one or more set-top box devices that are associated with an indicated dwelling, occupant, or any combination thereof, such as the set-top box device 114. The AV-TD 108 sends a signal, data, or any combination thereof, to the network terminal 110 indicating that a request to access an entrance has been received at the security system 102 and that the request is associated with the set-top box device 114. The network terminal 110 sends a signal, data, or any combination thereof, to the set-top box device 114 indicating that such a request has been received. The signal, data, or any combination thereof indicating that the request has been received can be separate from a signal, data, or any combination thereof that is carrying video content to the set-top box device 114. Alternatively, the signal, data, or any combination thereof indicating that the request has been received can be included with the signal, data, or any combination thereof that is carrying the video content.

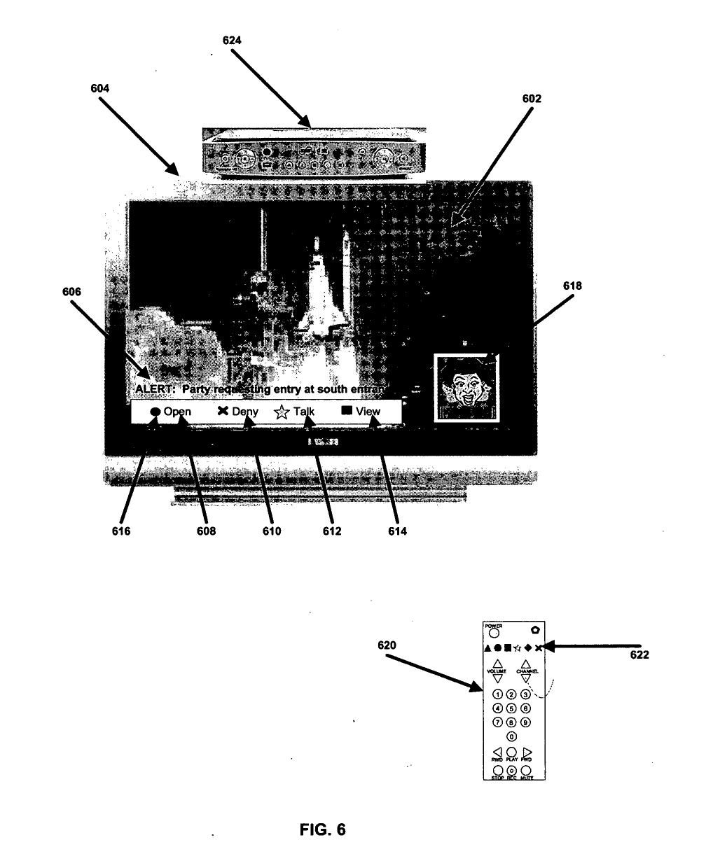

In an illustrative embodiment, an alert indicating that the party has requested access to the entrance can be displayed overlaying video content at the television monitor 120 coupled to the set-top box device 114. The alert can include a user interface 142 having one or more selectable commands, such as granting or denying access to the entrance, talking to the requesting party, viewing an image or video of the requesting party, or any combination thereof. In a particular embodiment, the user can select a command from the user interface 142 via a remote control device 122 that communicates with the set-top box device 114. An example of a user interface to control access to an entrance is illustrated in FIG. 6. In another embodiment, the user interface 142 can include a session invitation to view the request, the image or video of the party, the command options, or any combination thereof. The alert, user interface 142, or any combination thereof, can be generated by the AV-TD 108, the network terminal 110, set-top box device 114, or any combination thereof.

In a particular embodiment, a user can request to view an image or video of the party requesting access to the entrance. The set-top box device 114 can send the request to the network terminal 110, which sends a signal, data, or any combination thereof, to the AV-TD 108 indicating that a request to view an image or video of the party requesting access has been made. The AV-TD 108 can acquire a recorded image, recorded video, live video, or any combination thereof, from the video camera 104 of the security system 102 and can send the recorded image, recorded video, live video, or any combination thereof, to the set-top box device 114 via the network terminal 110. In another embodiment, an image, video, or any combination thereof, of the party can be received and recorded at the AV-TD 108 from the video camera 104 when the party requests access to the entrance, and the AV-TD 108 can retrieve the image, video, or any combination thereof, from its memory in response to a request.

In an illustrative embodiment, the recorded image, recorded video, live video, or any combination thereof, can be displayed at the television monitor 120 overlaying video content displayed in a video content region 125. For example, the recorded image, recorded video, live video, or any combination thereof, can be displayed in a picture-in-picture region 126. The recorded image, recorded video, live video, or any combination thereof, can be sent from the network terminal 110 to the set-top box 114 via a signal, data, or any combination thereof, that is separate from a signal, data, or any combination thereof, carrying the video content to the set-top box device 114. Alternatively, the recorded image, recorded video, live video, or any combination thereof, can be carried by the signal, data, or any combination thereof, carrying the video content. In a particular embodiment, the network terminal 110 can send the recorded image, recorded video, live video, or any combination thereof, to the set-top box device 114 via a unicast signal.

In another particular embodiment, the user can issue a command to talk to the party requesting access to the entrance. The set-top box device 114 can send a signal, data, or any combination thereof, to the AV-TD 108 via the network terminal 110 indicating that voice communications are to be facilitated between the security system 102 and the set-top box device 114, telephone 124, or any combination thereof. In an illustrative embodiment, the network terminal 110 and AV-TD 108 can include voice-processing portions that enable the exchange of voice communications between a microphone and speaker(s) at the keypad 106, for example, and the handset of the telephone 124. In another embodiment, voice communications can be sent by the user via a microphone at the set-top box device 114 or remote control 122, and voice communications can be received by the user via one or more speaker(s) at the set-top box device 114, television monitor 120, or any combination thereof.

In an illustrative embodiment, the user can issue a command to grant or deny access to the entrance via the set-top box device 114. For example, the user can select one or more commands on the user interface 142 via keys on the remote control 122. The set-top box device 114 can send signals, data, or any combination thereof, to the network terminal 110 indicating that a command to grant or deny access has been issued. The network terminal 110 can send signals, data, or any combination thereof, to the AV-TD 108 indicating the command that has been issued, and the AV-TD can send signals, data, or any combination thereof to the security system 102 indicating an action that is to be executed by the security system 102. For example, if a user issues a command to grant access to the entrance, the AV-TD 108 can instruct the security system 102 to open the entrance, unlock the entrance, supply the user with a code to open the entrance, or any combination thereof. Conversely, if the user issues a command to deny access to the entrance, the AV-TD 108 can instruct the security system 102 to indicate that access is denied via a screen of the keypad device 106.

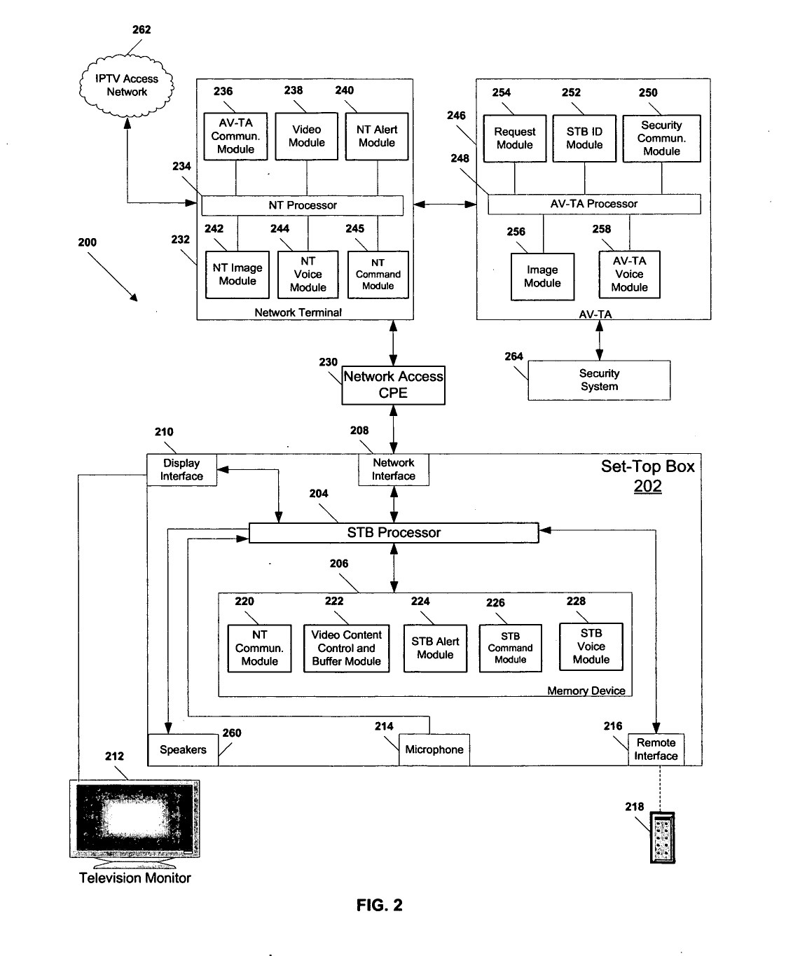

Referring to FIG. 2, a second particular embodiment of a system to control access to an entrance is illustrated and designated generally at 200. The system 200 includes a set-top box device 202 that communicates with a network terminal 232. In a particular embodiment, the network terminal 232 can communicate with an Internet Protocol Television (IPTV) access network 262. The network terminal 232 is coupled to an audio video transport device (AV-TD) 246 that communicates with a security system 264.

As indicated in FIG. 2, the set-top box device 202 includes a STB processor 204 and a memory device 266 accessible to the STB processor 204. In an illustrative embodiment, the STB processor 204 can communicate with the network terminal 232 via the network interface 208. In a particular embodiment, network access customer premises equipment (CPE) 230 can facilitate communication between the network interface 208 and the network terminal 232. The network access CPE 230 can include a router, a local area network device, a modem, such as a digital subscriber line (DSL) modem, any other suitable device to facilitate communication between the network interface 208 of the set-top box device 202 and the network terminal 232, or any combination thereof. Further, the STB processor 204 can communicate video content received from the network terminal 232 to a display device 212 via a display interface 210. In addition, the STB processor 204 can receive commands from a remote control device 218 via a remote interface 216.

In a particular embodiment, the memory device 206 can include a network terminal communication module 220 that is executable by the STB processor 204 to receive video content, alerts, recorded images, recorded video, live video, user interfaces, session invitations, or any combination thereof, from the network terminal 232 and to send indications of commands received at the set-top box device 202 to the network terminal 232. Further, the memory device 206 can include a video content control and buffer module 222 that is executable by the STB processor 204 to receive video content from the IPTV access network 262 via the network terminal 232 and to buffer the video content before sending it to the display interface 210, in order to prevent underflow.

In a particular embodiment, the memory device 206 can include an STB alert module 224 that is executable by the STB processor 204 to communicate alerts received from the network terminal 232 to the television monitor 212. In another embodiment, the STB alert module 224 can be executable by the STB processor 204 to communicate session invitations related to such alerts to the television monitor 212. In addition, the STB alert module 224 can be executable by the STB processor 204 to communicate a user interface related to an alert, session invitation, or any combination thereof to the television monitor 212. The memory device 206 can include a STB command module 226 to receive selections of commands within such a user interface from a remote control device 218, for example, and to send indications of the commands to the network terminal 232.

In another particular embodiment, the memory device 206 can include a STB voice-processing module 228 that is executable by the STB processor 204 to process voice communications received via the microphone 214 and to send the voice communications to the network terminal 232 for transmission to the security system 264 via the AV-TD 246. Further, the STB voice-processing module 228 can be executable by the STB processor 204 to process voice communications received from the network terminal 232 and to output the voice communications via the speaker(s) 260.

In a particular embodiment, the network terminal 232 can include a NT processor 234. The network terminal 232 can include an AV-TD communication module 236 that is executable by the NT processor 234 to receive entrance requests, alerts, user interfaces, recorded images or video, live video, voice communications, or any combination thereof, from the AV-TD 246 and to send commands, selections, voice communications, or any combination thereof, to the AV-TD 246. In addition, the network terminal 232 can include a video module 238 that is executable by the NT processor 234 to receive video content, for example, from a video server or D-server of an IPTV system via the IPTV access network 262, and to send the video content to the set-top box device 202. Further, the video module 238 can be executable by the NT processor 234 to send recorded images, recorded video, live video, or any combination thereof received from the AV-TD 246 to the set-top box device 202 with the video content, separate from the video content, as picture-in-picture content, or any combination thereof.

In another particular embodiment, the network terminal 232 can include an NT alert module 240 that is executable by the NT processor 234 to receive an indication from the AV-TD 246 that a party has requested access to an entrance. In an illustrative embodiment, the NT alert module 240 can be executable by the NT processor 234 to generate an alert indicating that such a request has been received at the security system 264. Moreover, the NT alert module 240 can be executable by the NT processor 234 to include with the alert a user interface having one or more selectable commands related to the request to access the entrance. In another embodiment, the NT alert module 240 can be executable by the NT processor 234 to receive the alert, user interface, or any combination thereof, from the AV-TD 246.

In another particular embodiment, the network terminal 232 can include an NT image module 242 that is executable by the NT processor 234 to receive a recorded image, recorded video, live video, or any combination thereof, from the AV-TD 246 and to send the recorded image, recorded video, live video, or any combination thereof, to the set-top box device 202. In an illustrative embodiment, the NT image module 242 can be executable by the NT processor 234 to receive a request or command from the set-top box device 202 for the recorded image, recorded video, live video, or any combination thereof. In another illustrative embodiment, the NT image module 242 can be executable by the NT processor 234 to receive the recorded image, recorded video, live video, or any combination thereof, from the AV-TD 246 with an indication of a request for access to an entrance, and to send the recorded image, recorded video, live video, or any combination thereof, to the set-top box device 202 with an alert that is related to the request.

In a particular embodiment, the network terminal 232 can include an NT voice-processing module 244 that is executable by the NT processor 234 to receive a signal or command from the set-top box device 202 indicating that voice communications are to be facilitated between the security system 264 and the set-top box device 202. Further, the NT voice-processing module 244 can be executable by the NT processor 234 to receive voice communications from the set-top box device 202 and to send data, signals, or any combination thereof, carrying the voice communications, to the AV-TD 246 for communication to the security system 264. In addition, the NT voice-processing module 244 can be executable by the NT processor 234 to receive voice communications from the AV-TD 246 and to send the voice communications to the set-top box device 202 for output at the speaker(s) 260, the display device 212, or any combination thereof.

In a particular embodiment, the network terminal 232 can include an NT command module 245 that is executable by the NT processor 234 to receive commands from the set-top box device 202 to grant or deny access to the entrance. The NT command module 245 can be executable by the NT processor 234 to send a signal, data, or any combination thereof, to the AV-TD 246 indicating the command that has been issued and is to be executed by the security system 102. In an illustrative embodiment, the various modules 236-245 can be included in a memory device of the network terminal 232 that is accessible to the NT processor 234.

In another particular embodiment, the AV-TD 246 can include an AV-TD processor 248. The AV-TD 246 can include a security communication module 250 that is executable by the AV-TD processor 248 to receive a request for access to an entrance from the security system 264. Further, the security communication module 250 can be executable by the AV-TD processor 248 to receive commands to grant or deny access to the entrance from the network terminal 232 and to send the commands to the security system 264 for execution.

Further, the AV-TD 246 can include a STB identification module 252 that is executable by the AV-TD processor 248 to determine one or more set-top box devices that are associated with an occupant, dwelling, or any combination thereof indicated in a request for access to an entrance. For example, the STB identification module 252 can include a data store that relates occupants, dwellings, or any combination thereof, to an Internet Protocol (IP) address of the set-top box device 202, a twisted pair connected with the set-top box device 202, the network interface 208, the CPE 230, another identifier of the set-top box device 202, or any combination thereof. The AV-TD 246 can include a request module 254 that is executable by the AV-TD processor 248 to send data, signals, or any combination thereof, to the network terminal 232 indicating that a request for access to an entrance has been received at the security system 264 and identifying a set-top box device associated with the request.

In a particular embodiment, the AV-TD 246 can include an image module 256 that is executable by the AV-TD processor 248 to receive a recorded image, recorded video, live video, or any combination thereof, from the security system 264 and to send the recorded image, recorded video, live video, or any combination thereof, to the network terminal 232. In an illustrative embodiment, the image module 256 can be executable by the AV-TD processor 248 to receive a request or command from the set-top box device 202 via the network terminal 232 for the recorded image, recorded video, live video, or any combination thereof. In another illustrative embodiment, the image module 256 can be executable by the AV-TD processor 234 to send the recorded image, recorded video, live video, or any combination thereof, to the network terminal 232 with an indication of a request for access to an entrance. In an illustrative embodiment, the image module 256 can be executable by the AV-TD processor 248 to permanently or temporarily store recorded images, recorded video, live video, or any combination thereof, received from the security system 264.

In a particular embodiment, the AV-TD 246 can include an AV-TD voice-processing module 258 that is executable by the AV-TD processor 248 to receive a signal or command from the network terminal 232 indicating that voice communications are to be facilitated between the security system 264 and the set-top box device 202. Further, the AV-TD voice-processing module 258 can be executable by the AV-TD processor 248 to receive voice communications from the network terminal 232 and to send data, signals, or any combination thereof, carrying the voice communications, to the security system 264. In addition, the AV-TD voice-processing module 258 can be executable by the AV-TD processor 248 to receive voice communications from the security system 264 and to send the voice communications to the network terminal 232 for transmission to the set-top box device 202.

In a particular embodiment, a party seeks entrance to a dwelling via the security system 264. For example, the party can request access to an entrance, such as a gate or door at a private home. The security system 264 can send a signal to the AV-TD 246 indicating that a party seeks access to the entrance. The security communication module 250 can be executable by the AV-TD processor 248 to receive the signal, and the set-top box identification module 252 can be executable by the AV-TD processor 248 to identify one or more set-top box devices that are associated with the dwelling, an occupant of the dwelling, or any combination thereof, such as the set-top box device 202. The request module 248 can be executable by the AV-TD processor 248 to send a signal to the network terminal 232 indicating that a request to access the entrance has been received at the security system 264 and that the request is associated with the dwelling, occupant, the set-top box device 202, or any combination thereof. The NT alert module 240 can be executable by the NT processor 234 to send an alert to the set-top box device 202 indicating that such a request has been received. The alert can be carried by a signal that is separate from a signal carrying a video stream to the set-top box device 202. Alternatively, the alert can be carried by the signal carrying the video stream.

In an illustrative embodiment, the STB alert module 224 can be executable by the STB processor 204 to display an alert indicating a request for access to the entrance overlaying video content at the television monitor 212. In a particular embodiment, the alert can include a user interface to select an action based on the alert, such as granting or denying access to the requesting party, talking to the requesting party, viewing an image or video of the requesting party, or any combination thereof. The user can select an action form the user interface via a remote control device 218.

For example, the STB command module 226 can be executable by the STB processor 204 to receive a command to view an image or video of the party requesting access to the entrance. The STB command module 226 can be executable by the STB processor 204 to send the request to the network terminal 232. The NT image module 242 can be executable by the NT processor 234 to receive the request and send a signal, data, or any combination thereof, to the AV-TD 246 requesting the image or video of the party requesting access. The AV-TD image module 256 can be executable by the AV-TD processor 238 to acquire the recorded image, recorded video, live video, or any combination thereof, from the security system 264, from a memory portion of the AV-TD 246, or any combination thereof, and to send the recorded image, recorded video, live video, or any combination thereof, to the network terminal 232. The NT image module 242 can be executable by the NT processor 234 to send the recorded video, live video, or any combination thereof, to the set-top box device 202.

In an illustrative embodiment, the recorded image, recorded video, live video, or any combination thereof, can be displayed on the television monitor 212 overlaying video content. For example, the recorded image, recorded video, live video, or any combination thereof, can be displayed in a picture-in-picture region. The NT image module 242 can be executable by the NT processor 248 to send the recorded image, recorded video, live video, or any combination thereof, to the set-top box 202 via a signal that is separate from a signal carrying a video stream to the set-top box device 202. Alternatively, the NT image module 242 can be executable by the NT processor 248 to send the recorded image, recorded video, live video, or any combination thereof, can be carried by the signal carrying the video stream. In a particular embodiment, the NT image module 242 can be executable by the NT processor 248 to send the recorded image, recorded video, live video, or any combination thereof, to the set-top box device 202 via a unicast signal.

In another particular embodiment, the STB command module 226 can be executable by the STB processor 204 to receive a command to talk to the party requesting access to the entrance. The STB command module 226 can be executable by the STB processor 204 to send the command to the network terminal 232 indicating that voice communications are to be facilitated between the security system 264 and the set-top box device 202. In an illustrative embodiment, the NT voice-processing module 244 can be executable by the NT processor 234 to receive voice communications from the set-top box device 202 and to send data, signals, or any combination thereof, carrying the voice communications, to the AV-TD 246 for communication to the security system 264. In addition, the NT voice-processing module 244 can be executable by the NT processor 234 to receive voice communications from the AV-TD 246 and to send the voice communications to the set-top box device 202 for output at the speaker(s) 260, the display device 212, or any combination thereof. In addition, the AV-TD voice-processing module 258 can be executable by the AV-TD processor 248 to receive voice communications from the set-top box 202 via the network terminal 232 and to send data, signals, or any combination thereof, carrying the voice communications, to the security system 264. Moreover, AV-TD voice-processing module 258 can be executable by the AV-TD processor 248 to receive voice communications from the security system 264 and to send the voice communications to the network terminal 232.

In an illustrative embodiment, the user can issue a command to grant or deny access to the entrance via the set-top box device 202. For example, the STB command module 226 can be executable by the STB processor 204 to receive selections of one or more commands on a user interface via the remote control 218. The STB command module 226 can be executable by the STB processor 204 to send signals, data, or any combination thereof, to the network terminal 232 indicating that a command to grant or deny access has been issued. Further, the NT command module 245 can be executable by the NT processor 234 to send a signal to the AV-TD 246 indicating the command that has been issued, and the security communication module 250 can be executable by the AV-TD processor 248 to send a signal to the security system 264 indicating an action that is to be executed. For example, if a user issues a command to grant access to the entrance, the security system 264 could open the entrance, unlock the entrance, supply the user with a code to open the entrance, or any combination thereof. Conversely, if the user issues a command to deny access to the entrance, the security system 264 could indicate that access is denied via a screen of the keypad device.

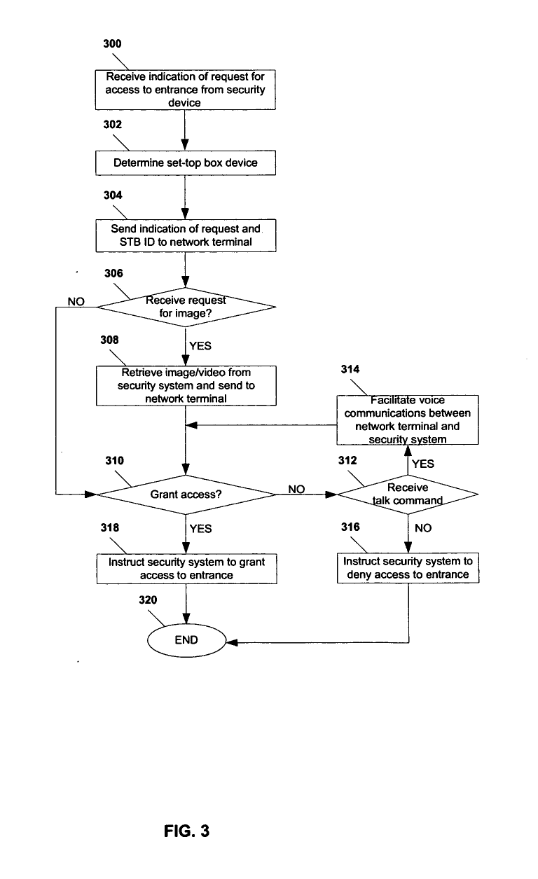

Referring to FIG. 3, a particular embodiment of a method of controlling access to an entrance is illustrated. At block 300, an audio video transport device (AV-TD) receives an indication that a request for access to an entrance has been received at a security system. In a particular embodiment, the request can identify a dwelling, occupant, or any combination thereof. Moving to block 302, in an illustrative embodiment, the AV-TD can identify a set-top box device that is associated with the dwelling, occupant, or any combination thereof, indicated in the request.

Proceeding to block 304, the AV-TD sends signals, data, or any combination thereof, to a network terminal indicating that a request for access to the entrance has been received at the security system. In an illustrative embodiment, the AV-TD can also send an identification of the set-top box device associated the dwelling, occupant, or any combination thereof, indicated in the request. The network terminal can send signals, data, or any combination thereof, to the set-top box device indicating that the request has been received, and an alert can be displayed at a display device coupled to the set-top box device.

Continuing to decision step 306, the AV-TD can determine whether it has received a request for a recorded image, recorded video, live video, or any combination thereof, of the party requesting access from the network terminal. For example, a user can request the recorded image, recorded video, live video, or any combination thereof, via a user interface displayed at the display device coupled to the set-top box device. If the AV-TD determines that it has not received such a request the method advances to decision step 310 and continues. Conversely, in a particular embodiment, if the AV-TD has received such a request, the method moves to block 308, and the AV-TD can retrieve the recorded image, recorded video, live video, or any combination thereof, from the security system and send the recorded image, recorded video, live video, or any combination thereof, to the network terminal for transmission to the set-top box device. The method then continues to decision step 310.

At decision step 310, the AV-TD determines whether it has received a command to instruct the security system to grant access to the entrance. For example, a user can issue the command via a user interface displayed at the display device coupled to the set-top box device. If the AV-TD determines that it has received such a command, the method proceeds to block 318, and the AV-TD can instruct the security system to grant access to the entrance.

Returning to decision step 310, if the AV-TD determines that it has not received a command to instruct the security system to grant access to the entrance, the method moves to decision step 312, and the AV-TD determines whether it has received a command to facilitate voice communications between the security system and the network terminal. If the AV-TD determines that it has received a command to facilitate voice communications, the method moves to block 314, and the AV-TD send voice communications between the security system and the network terminal. In a particular embodiment, the method returns to decision step 310. On the other hand, if the AV-TD determines that it has not received a command to facilitate voice communications, the method continues to block 316, and the AV-TD sends instructions to the security system to deny access to the entrance. The method terminates at 320.

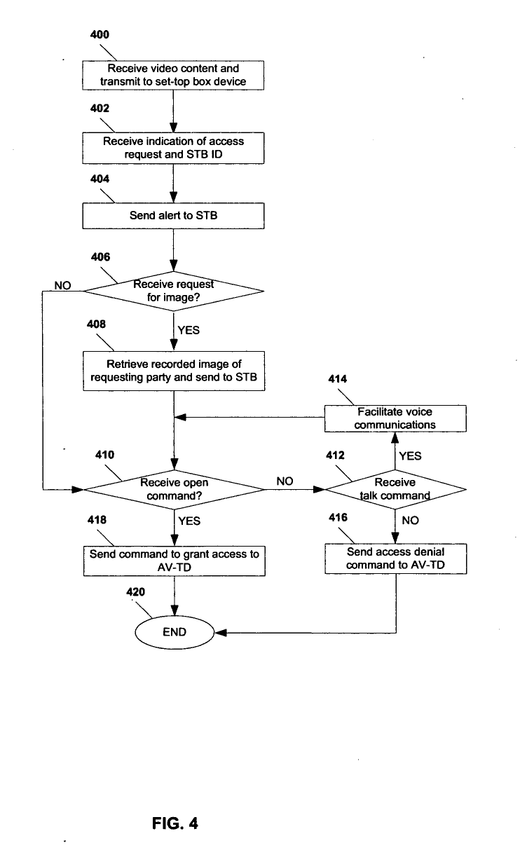

Referring to FIG. 4, a second particular embodiment of a method of controlling access to an entrance is illustrated. At block 400, a network terminal receives video content and sends the video content to a set-top box device. In an illustrative embodiment, the network terminal can receive the video content from one or more servers of an Internet Protocol Television (IPTV) system via an IPTV access network. Moving to block 402, the network terminal receives a signal, data, or any combination thereof, from an audio video transport device (AV-TD) indicating that a request to access an entrance has been received at a security system. In an illustrative embodiment, the signal, data, or any combination thereof, can include an identification of a set-top box device associated with an occupant, dwelling, or any combination thereof, indicated in the request.

Proceeding to block 404, in a particular embodiment, the network terminal sends data, signals, or any combination thereof to the set-top box device, which include an alert indicating that the request for access to the entrance has been received. In an illustrative embodiment, the network terminal can generate the alert. In another embodiment, the network terminal can receive the alert from the AV-TD. The network terminal can send the alert to the set-top box device with a signal, data, or any combination thereof, carrying the video content. Alternatively, the network terminal can send the alert to the set-top box device via a separate signal, data, or any combination thereof. In a particular embodiment, the alert can be displayed at a display device coupled to the set-top box device overlaying the video content carried by the video stream. Further, the alert can include a user interface having selectable commands related to the request to access the entrance.

Continuing to decision step 406, the network terminal can determine whether it has received a request from the set-top box device for a recorded image, recorded video, live video, or any combination thereof, of the party requesting access to the entrance. For example, a user can request the recorded image, recorded video, live video, or any combination thereof, via a user interface displayed at the display device. If the network terminal determines that it has not received such a request the method advances to decision step 410 and continues. Conversely, in a particular embodiment, if the network terminal has received such a request, the method moves to block 408, and the network terminal can retrieve the recorded image, recorded video, live video, or any combination thereof, from the AV-TD and send the recorded image, recorded video, live video, or any combination thereof, to the set-top box device. The method then continues to decision step 410.

At decision step 410, the network terminal determines whether it has received a command to grant access to the entrance. For example, a user can issue the command via the user interface displayed at the display device. If the network terminal determines that it has received such a command, the method proceeds to block 418, and the network terminal can send a signal, data, or any combination thereof, to the AV-TD indicating that access is to be granted at the security system.

Returning to decision step 410, if the network terminal determines that it has not received a command to grant access to the entrance, the method moves to decision step 412, and the network terminal determines whether it has received a command to facilitate voice communications between the set-top box device and the AV-TD. If the network terminal determines that it has received a command to facilitate voice communications, the method moves to block 414, and the network terminal sends voice communications between the set-top box device and the AV-TD. In a particular embodiment, the method returns to decision step 410. On the other hand, if the network terminal determines that it has not received a command to facilitate voice communications, the method continues to block 416, and the network terminal sends data, signals, or any combination thereof, to the AV-TD indicating that the security system is to deny access to the entrance. The method terminates at 420.

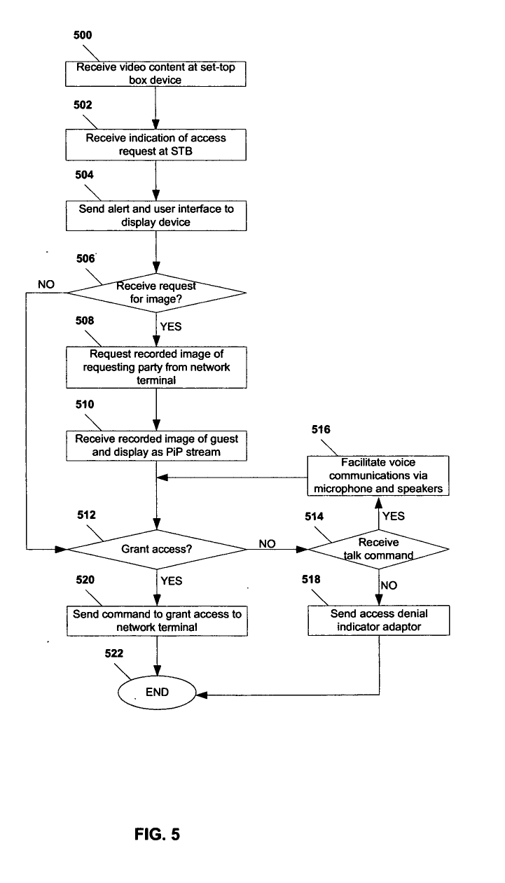

Referring to FIG. 5, a third particular embodiment of a method of controlling access to an entrance is illustrated. At block 500, a set-top box device receives video content from a network terminal. In an illustrative embodiment, the set-top box device can receive video content of an Internet Protocol Television (IPTV) system. Moving to block 502, the set-top box device receives a signal, data, or any combination thereof, from the network terminal indicating that a request for access to an entrance has been received at a security system. Proceeding to block 504, the set-top box device sends an alert indicating that the request has been received to a display device. In an illustrative embodiment, the network terminal can generate the alert. In another embodiment, the network terminal can receive the alert from the AV-TD. In another embodiment, the set-top box device can generate the alert. Further, the alert can include a user interface having selectable commands related to the request to access the entrance. The alert can include a user interface and can overlay video content displayed at the display device.

Continuing to decision step 506, the set-top box device can determine whether it has received a request for a recorded image, recorded video, live video, or any combination thereof, of the party requesting access to the entrance. For example, a user can request the recorded image, recorded video, live video, or any combination thereof, via a user interface displayed at the display device. If the set-top box device determines that it has not received such a request the method advances to decision step 512 and continues. Conversely, in a particular embodiment, if the set-top box device has received such a request, the method moves to block 508, and the set-top box device can send a request for the recorded image, recorded video, live video, or any combination thereof, to the network terminal. Moving to block 510, the set-top box device receives the recorded image, recorded video, live video, or any combination thereof, and sends it to the display device. In an illustrative embodiment, the recorded image, recorded video, live video, or any combination thereof, can be displayed as a picture-in-picture stream at the display device. The method continues to decision step 512.

At decision step 512, the set-top box device determines whether it has received a command to grant access to the entrance. For example, a user can issue the command via the user interface displayed at the display device. If the set-top box device determines that it has received such a command, the method proceeds to block 520, and the set-top box device can send a signal, data, or any combination thereof, to the network terminal indicating that the requesting party is to be granted access to the entrance via the security system.

Returning to decision step 512, if the set-top box device determines that it has not received a command to grant access to the entrance, the method moves to decision step 514, and the set-top box device determines whether it has received a command to facilitate voice communications with the security system. If the set-top box device determines that it has received a command to facilitate voice communications, the method moves to block 516, and the set-top box device can receive voice communications via a microphone at the set-top box device or a remote control device that communicates with the set-top box device and send the voice communications to the security system via the network terminal. Further, the set-top box device can receive voice communications from security system via the network terminal and output the voice communications via one or more speakers at the set-top box device, one or more speakers at the display device coupled to the set-top box device, or any combination thereof. In a particular embodiment, the method returns to decision step 512.

Returning to decision step 514, if the set-top box device determines that it has not received a command to facilitate voice communications, the method continues to block 518, and the set-top box device sends data, signals, or any combination thereof, to the network terminal indicating that the security system is to deny access to the entrance. The method terminates at 522.

In a particular embodiment, the steps of the methods described herein are executed in the order shown by the figures. In alternative embodiments, the steps may be executed in alternative sequences. For example, commands to grant access to an entrance, deny access to an entrance, talk to a requesting party, or request images or video can be executed in any order or simultaneously.

Referring to FIG. 6, a graphical user interface (GUI) to control access to an entrance is illustrated. In a particular embodiment, the GUI can overlay a video content region 602 that displays video content at a display device 604. The GUI includes an alert 606 that informs a user that a party seeks access to an entrance, such as a particular entrance to a dwelling, a property, a neighborhood, a multiple dwelling unit complex, or any combination thereof, via a security system.

In a particular embodiment, one or more selectable commands 608-614 can be included with the alert and can overlay the video content region 602. For example, the GUI can include a selectable command to grant access to the entrance, such as an ‘OPEN’ command 608 or similar command. The user can select the ‘OPEN’ command 608 to cause the security system to grant the requesting party access to the entrance. Further, the GUI can include a selectable command to deny access to the entrance, such as a ‘DENY’ command 610 or similar command. The user can select the ‘DENY’ command 610 to cause the security system to inform the requesting party that access to the entrance is denied. In addition, the GUI can include a selectable command to talk to the requesting party, such as a ‘TALK’ command 612 or similar command. The user can select the ‘TALK’ command 612 to exchange voice communications with the requesting party, by using a telephone handset, a microphone and speakers at a set-top box device, a microphone at a remote control, speakers at the display device 604, or any combination thereof.

In a particular embodiment, an image, video, or any combination thereof, can be included with the alert. In another particular embodiment, the GUI can include a selectable command to view an image, video, or any combination thereof, of the requesting party, such as a ‘VIEW’ command 614 or similar command. The user can select the ‘VIEW’ command 614 to view the image, video, or any combination thereof on the display device 604. In an illustrative embodiment, the image, video, or any combination thereof, can be presented, for example, in a picture-in-picture (PiP) region 618 overlaying the video content region 602. In an illustrative embodiment, a user can swap the video content to the PiP region and the image, video, or any combination thereof of a requesting party to the video content region 602. For example, a user can issue a command to enlarge the image or video of the requesting party.

In a particular embodiment, the commands 608-614 presented with an alert can be selectable using a remote control device 620 that communicates with a set-top box device 624 that is coupled to the display device 604. In an illustrative, non-limiting embodiment, one or more shapes 608 corresponding to shaped keys 622 on the remote control device 620 can be presented with each command. In another embodiment, a user can select commands 608-614 using directional keys, an ‘OK’ key, an ‘ENTER’ key, a ‘SELECT’ key, or any combination thereof.

In conjunction with the configuration of structure described herein, the system and method disclosed allow a user to control access to an entrance via a set-top box device. In an illustrative embodiment, a party can seek access to an entrance, such as a door of a dwelling, a gate or door of a multiple dwelling unit building or complex, an entrance to a property, or any combination thereof, via a security system that includes a camera. For example, the party can use a keypad device of the security system to request access to an entrance. In response to the request, the security system can send a signal, data, or any combination thereof, to an audio video transport device (AV-TD) indicating that a party seeks access to the entrance. In an illustrative embodiment, the request can identify a particular dwelling, occupant, or any combination thereof.

In a particular embodiment, the AV-TD can identify one or more set-top box devices that are associated with an indicated dwelling, occupant, or any combination thereof. The AV-TD sends a signal, data or any combination thereof, to a network terminal that communicates video streams to the set-top box device, indicating that a request to access an entrance has been received at the security system and that the request is associated with the dwelling, occupant, the set-top box device, or any combination thereof. The network terminal sends a signal, data, or any combination thereof, to the set-top box device indicating that such a request has been received. The signal, data, or any combination thereof, can be carried by a signal that is separate from a signal carrying a video stream to the set-top box device. Alternatively, the signal, data, or any combination thereof, can be carried by the signal carrying the video stream.

In an illustrative embodiment, an alert can be displayed overlaying video content at a display device coupled to the set-top box device. Further, a user interface can be included with the alert that includes one or more commands, such as granting or denying access to the entrance, talking to the requesting party, viewing an image or video of the requesting party, or any combination thereof. In a particular embodiment, the user can select an action from the user interface via a remote control device that communicates with the set-top box device. In another embodiment, the user interface can include a session invitation to view the request, an image or video of the party, command options, or any combination thereof. The alert, user interface, or any combination thereof, can be generated by the AV-TD, the network terminal, the set-top box device, or any combination thereof.

In a particular embodiment, a user can request to view an image or video of the party requesting access to the entrance. The set-top box device can send the request to the network terminal, which sends a signal, data, or any combination thereof, to the AV-TD indicating that a request to view an image or video of the party requesting access has been made. The AV-TD can acquire a recorded image, recorded video, live video, or any combination thereof, from the video camera of the security system and can send the recorded image, recorded video, live video, or any combination thereof, to the set-top box device via the network terminal. In another embodiment, an image, video, or any combination thereof, of the party can be received and recorded at the AV-TD from the video camera when the party requests access to the entrance, and the AV-TD can retrieve the image, video, or any combination thereof, from its memory in response to a request.

In an illustrative embodiment, the recorded image, recorded video, live video, or any combination thereof, can be displayed at the display device overlaying video content. For example, the recorded image, recorded video, live video, or any combination thereof, can be displayed in a picture-in-picture region. The recorded image, recorded video, live video, or any combination thereof, can be sent from the network terminal to the set-top box via a signal, data, or any combination thereof, that is separate from a signal, data, or any combination thereof, carrying a video stream to the set-top box device. Alternatively, the recorded image, recorded video, live video, or any combination thereof, can be carried by the signal, data, or any combination thereof, carrying the video stream. In a particular embodiment, the network terminal can send the recorded image, recorded video, live video, or any combination thereof, to the set-top box device via a unicast signal.

In another particular embodiment, the user can issue a command to talk to the party requesting access to the entrance. The set-top box device can send a signal, data, or any combination thereof, to the AV-TD via the network terminal indicating that voice communications are to be facilitated between the security system and the set-top box device, a telephone device, or any combination thereof. In an illustrative embodiment, the network terminal and AV-TD can include voice-processing portions that enable the exchange of voice communications between a microphone and speaker(s) at the keypad, for example, and the handset of the telephone device. In another embodiment, voice communications can be sent by the user via a microphone at the set-top box device or remote control, and voice communications can be received by the user via one or more speaker(s) at the set-top box device, television monitor, or any combination thereof.

In an illustrative embodiment, the user can issue a command to grant or deny access to the entrance via the set-top box device. For example, the user can select one or more commands on the user interface via keys on the remote control. The set-top box device can send a signal, data, or any combination thereof, to the network terminal indicating that a command to grant or deny access has been issued. The network terminal can send a signal, data, or any combination thereof to the AV-TD indicating the command that has been issued, and the AV-TD can send a signal, data, or any combination thereof, to the security system indicating an action that is to be executed by the security system. For example, if a user issues a command to grant access to the entrance, the security system can open the entrance, unlock the entrance, supply the user with a code to open the entrance, or any combination thereof. Conversely, if the user issues a command to deny access to the entrance, the security system can indicate that access is denied via a screen of the keypad device.

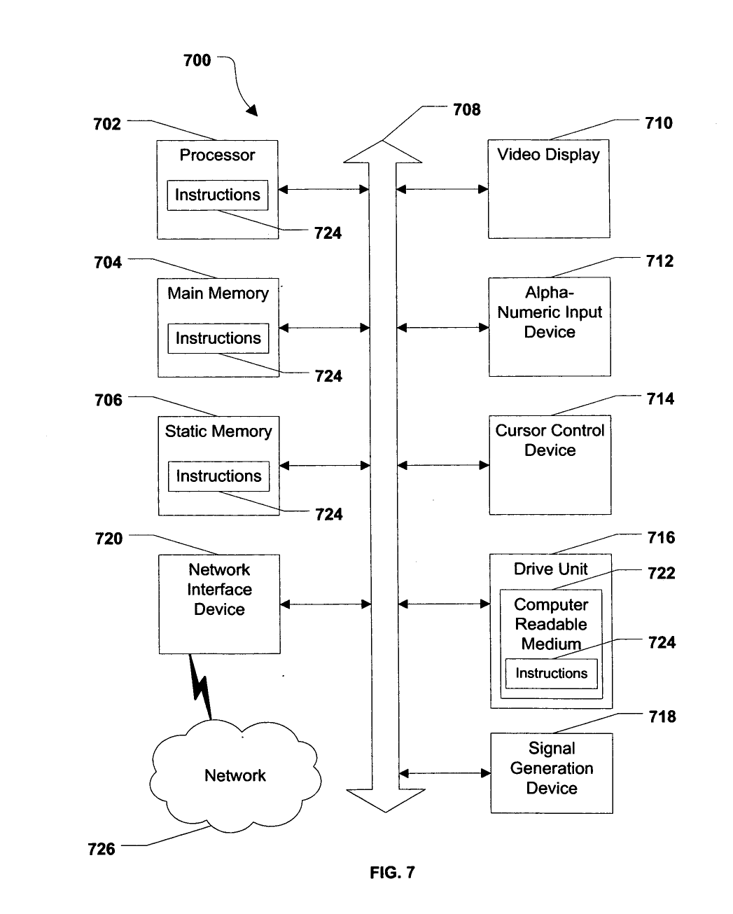

Referring to FIG. 7, an illustrative embodiment of a general computer system is shown and is designated 700. The computer system 700 can include a set of instructions that can be executed to cause the computer system 700 to perform any one or more of the methods or computer based functions disclosed herein. The computer system 700, or any portion thereof, may operate as a standalone device or may be connected, e.g., using a network, to other computer systems or peripheral devices, including a security system, an audio video transport device (AV-TD), a network terminal, or set-top box device, as shown in FIGS. 1-2.

In a networked deployment, the computer system may operate in the capacity of a security system, an AV-TD, network terminal or set-top box device. The computer system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics-processing unit (GPU), or both. Moreover, the computer system 700 can include a main memory 704 and a static memory 706 that can communicate with each other via a bus 708. As shown, the computer system 700 may further include a video display unit 710, such as a liquid crystal display (LCD), an organic light emitting diode (OLED), a flat panel display, a solid state display, or a cathode ray tube (CRT). Additionally, the computer system 700 may include an input device 712, such as a keyboard, and a cursor control device 714, such as a mouse. Further, the computer system 700 can include a wireless input device 715, e.g., a remote control device. The computer system 700 can also include a disk drive unit 716, a signal generation device 718, such as a speaker or remote control, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal, so that a device connected to a network 726 can communicate voice, video or data over the network 726. Further, the instructions 724 may be sent or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of controlling access to an entrance, the method comprising:
receiving a first signal, first data, or any combination thereof, at an audio video transport system indicating that a request to access an entrance has been received via a security system;
determining a set-top box device associated with the request;
sending a second signal, second data, or any combination thereof, to a network terminal indicating that the request has been received, wherein the network terminal communicates video content of an Internet Protocol Television (IPTV) system to the set-top box device; and
wherein the network terminal communicates an alert to the set-top box device indicating that the request has been received, the alert overlaying the video content at a display device coupled to the set-top box device.

2. The method of claim 1, further comprising sending to the network terminal a recorded image, recorded video, live video, or any combination thereof showing a party requesting access to the entrance, wherein the recorded image, recorded video, live video, or any combination thereof is displayed overlaying the video content at the set-top box device.

3. The method of claim 2, further comprising receiving a command signal, command data, or any combination thereof, from the network terminal indicating that a command to view an image or video of a party issuing the request has been received at the set-top box device.

4. The method of claim 1, further comprising:
receiving a command signal, command data, or any combination thereof, from the network terminal indicating that a command to grant access to the entrance has been received from the set-top box device; and
instructing the security system to grant access to the entrance.

5. The method of claim 1, further comprising:
receiving a command signal, command data, or any combination thereof, from the network terminal indicating that a command to deny access to the entrance has been received from the set-top box device; and
instructing the security system to deny access to the entrance.

6. The method of claim 1, further comprising:
receiving a command signal, command data, or any combination thereof, from the network terminal indicating that a command to talk to the party requesting access to the entrance has been received from the set-top box device; and
facilitating voice communication between the security system and the set-top box device.

7. The method of claim 1, wherein the audio video transport system generates the alert and communicates the alert to the network terminal.

8. A method of controlling access to an entrance, the method comprising:
sending video content of an Internet Protocol Television (IPTV) system to a set-top box device;
receiving a signal, data, or any combination thereof, from an audio video transport system indicating that a request to access an entrance has been received via a security system, wherein the signal, data, or any combination thereof includes an identification of the set-top box device; and
communicating an alert to the set-top box device indicating that the request has been received, the alert overlaying the video content at a display device coupled to the set-top box device.

9. The method of claim 8, wherein the network terminal includes the alert with a video signal, video data, or any combination thereof, that carries the video content of the IPTV system.

10. The method of claim 8, wherein the network terminal communicates the alert to the set-top box device via an alert signal, alert data, or any combination thereof, that does not carry the video content of the IPTV system.

11. The method of claim 8, further comprising:
receiving a command signal, command data, or any combination thereof, from the set-top box device indicating that a command to talk to the party requesting access to the entrance has been received; and
facilitating voice communication between the security system and the set-top box device.

12. The method of claim 8, further comprising generating the alert.

13. A method of controlling access to an entry, the method comprising:
receiving video content of an Internet Protocol Television (IPTV) system at a set-top box device from a network terminal;
receiving a signal, data, or any combination thereof, from the network terminal indicating that a request to access an entrance has been received at a security system that communicates with the network terminal via an audio video transport system; and
sending an alert to a display device coupled to the set-top box device, wherein the alert indicates that the request has been received and overlays video content at the display device.

14. The method of claim 13, further comprising sending a user interface to the display device, wherein the user interface includes a plurality of selectable commands related to the alert.

15. The method of claim 14, wherein the plurality of selectable commands includes a command to grant access to the entrance, a command to deny access to the entrance, a command to talk to the party requesting access to the entrance, a command to view the party requesting access to the entrance, or any combination thereof.

16. The method of claim 14, wherein the alert, the user interface, or any combination thereof, is generated by the set-top box device based on the signal, data, or any combination thereof received form the network terminal.

17. A system, comprising:
an audio video transport device having a processor and a memory device accessible to the processor;
wherein the memory device includes instructions executable by the processor to receive a first signal, first data, or any combination thereof, from a security system indicating that a request to access an entrance has been received;
wherein the memory device includes instructions executable by the processor to determine a set-top box device associated with the request;
wherein the memory device includes instructions executable by the processor to send a second signal, second data, or any combination thereof, to a network terminal indicating that the request has been received, wherein the network terminal communicates video content of an Internet Protocol Television (IPTV) system to the set-top box device; and
wherein the network terminal communicates an alert to the set-top box device indicating that the request has been received, the alert overlaying the video content at a display device coupled to the set-top box device.

18. The system of claim 17, wherein the audio video transport device receives the first signal, first data, or any combination thereof, from a keypad device of the security system.

19. The system of claim 17, wherein the memory device includes:
instructions to receive, from a camera of the security system, a recorded image, recorded video, live video, or any combination thereof, showing a party requesting access to the entrance; and
instructions to send the recorded image, recorded video, live video, or any combination thereof, to the network terminal, wherein the recorded image, recorded video, live video, or any combination thereof is displayed overlaying the video content at the set-top box device.

20. The system of claim 17, wherein:
the first signal, first data, or any combination thereof, indicates an occupant, dwelling, property, or any combination thereof associated with the request; and
the memory device includes instructions to associated the occupant, dwelling, property, or any combination thereof, with the set-top box device.

21. A set-top box device, comprising:
a processor and a memory device accessible to the processor;
wherein the memory device includes instructions executable by the processor to receive video content of an Internet Protocol Television (IPTV) system from a network terminal;
wherein the memory device includes instructions executable by the processor to receive a signal, data, or any combination thereof, from the network terminal indicating that a request to access an entrance has been received at a security system that communicates with the network terminal via an audio video transport system; and
wherein the memory device includes instructions executable by the processor to send an alert to a display device coupled to the set-top box device, the alert indicating that the request has been received and overlaying the video content at the display device.

22. The set-top box device of claim 21, wherein the memory device includes:
instructions to receive a selection of a command to view the party requesting access to the entrance;
instructions to send a request to obtain an image, video, or any combination thereof, to the network terminal; and
instructions to receive the image, video, or any combination thereof, via the network terminal, wherein the image, video, or any combination thereof, is displayed at the display device.

23. The set-top box device of claim 21, wherein the image, video, or any combination thereof, is displayed within a picture-in-picture region at the display device.

24. The set-top box device of claim 23, wherein the memory device includes:
instructions to receive a command to enlarge the image, video, or any combination thereof; and
wherein the image, video, or any combination thereof is displayed in a video content region of the display device and the video content is displayed in the picture-in-picture region at the display device, in response to the command.
